(19) United States
(12) Patent Application Publication
(10) Pub. No.: US 2016/0146608 A1
(43) Pub. Date: May 26, 2016

(54) AUTOMATIC TOUR GUIDING METHOD

(71) Applicants: INVENTEC (PUDONG) TECHNOLOGY CORPORATION, Shanghai City (CN); INVENTEC CORPORATION, Taipei City (TW)

(72) Inventor: TING-YU HU, Taipei City (TW)

(21) Appl. No.: 14/677,497

(22) Filed: Apr. 2, 2015

(30) Foreign Application Priority Data
Nov. 26, 2014 (CN) 201410692467.7

(51) Int. Cl. G01C 21/00

(52) U.S. Cl. CPC G01C 21/00

(57) ABSTRACT

An automatic tour guiding method applied to a server includes the following steps. Generate a time commend and a destination commend according to a user commend. Set time indexes according to the time command. Select place information in a place database according to the destination command. Each piece of place information corresponds to a first weight value. The first weight values is related to a distance between a departure place and a place of one piece of place information. Make the place information correspond to the time indexes according to the first weight values to produce and output a travel schedule.

### CROSS-REFERENCE TO RELATED APPLICATIONS

This non-provisional application claims priority under 35 U.S.C. §119(a) on Patent Application No(s). 201410692467.7 filed in China on 2014 Nov. 26, the entire contents of which are hereby incorporated by reference.

### BACKGROUND OF THE INVENTION

1. Technical Field of the Invention

The disclosure is related to an automatic tour guiding method, more particularly to a method of establishing a travel schedule according to the user's travel requirements.

2. Description of the Related Art

Travel mainly has two forms, one is individual travel (or backpacking) and the other one is guided tour (referred to as package tour).

Individual travel is popular now since individual tourists can plan their trip according to their interests. However, individual tourists need to research, collect and arrange travel information and plan a trip before departure. If the traveler is not familiar with the environment and traffic state of a place and transfers in the trip are not good, it will waste lots of time on dealing with such problems.

On the other hand, guided tours are usually provided by tour operators. A tour operator plans a travel schedule and assigns a tour guider to a tour group in advance, so travelers in the tour group can directly start their trip and obtain travel information from the tour guider without research and planning. Because the travel schedule is made for the public, the travel schedule is hard to be modified according to personal or familial requirements. Moreover, assigning a tour operator to plan a specific travel schedule and hiring a personal tour guider need an extra travel fee.

In view of such situations, an automatic tour guiding method capable of automatically planning a travel schedule and providing a tour guide is needed in order to support individual tourists and reduce travel costs.

### SUMMARY OF THE INVENTION

According to one or more embodiments, the disclosure provides an automatic tour guiding method applied to a server. In one embodiment, the automatic tour guiding method includes the following steps. The server produces a time command and a destination command according to a user command. The server sets a plurality of time indexes according to the time command and selects a plurality of pieces of place information from a place database according to a destination command. Each piece of place information corresponds to one of first weight values. The first weight value is related to a distance between a departure place and a place related to the place information. The server makes the place information correspond to the time indexes in order to produce a travel schedule according to the first weight values.

In other one embodiment, the server produces a tourism type command according to a user command and selects the place information from the place database according to the destination command and the tourism type command.

In other one embodiment, the place information in the place database is sorted into a plurality of place categories. One place category corresponds to a second weight value. The second weight value is related to the plurality of pieces of time information corresponding to the place category. The server further makes the place information correspond to the plurality of time indexes according to the first and second weight values, to set the travel schedule.

### BRIEF DESCRIPTION OF THE DRAWINGS

The present invention will become more fully understood from the detailed description given hereinbelow and the accompanying drawings which are given by way of illustration only and thus are not limitative of the present invention and wherein:

FIG. 1 is a flow chart of an automatic tour guiding method according to an embodiment of the disclosure;

FIG. 2 is a schematic diagram of a travel schedule according to an embodiment of the disclosure;

FIG. 3 is a schematic diagram of a requirement menu according to an embodiment of the disclosure; and

FIG. 4 is a schematic diagram of a travel schedule according to an embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

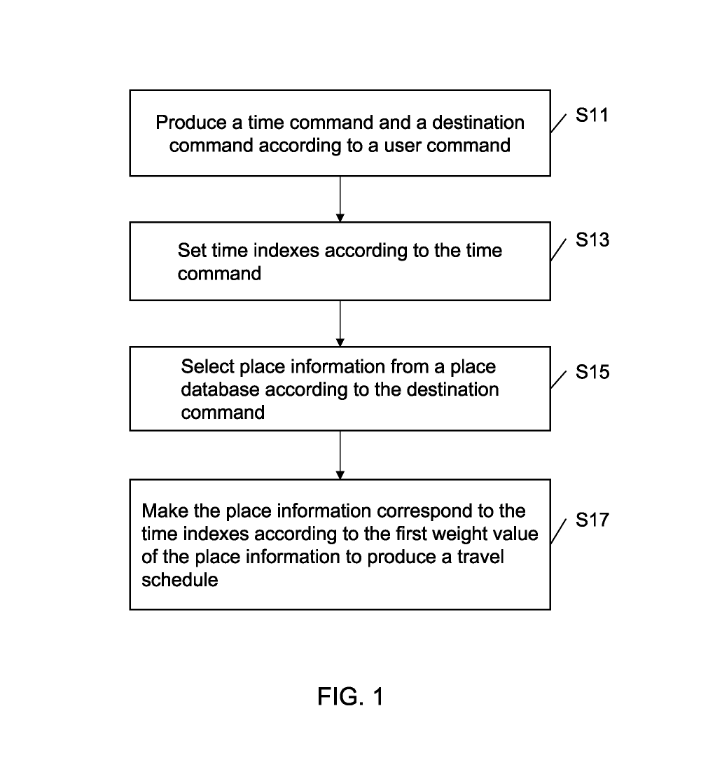

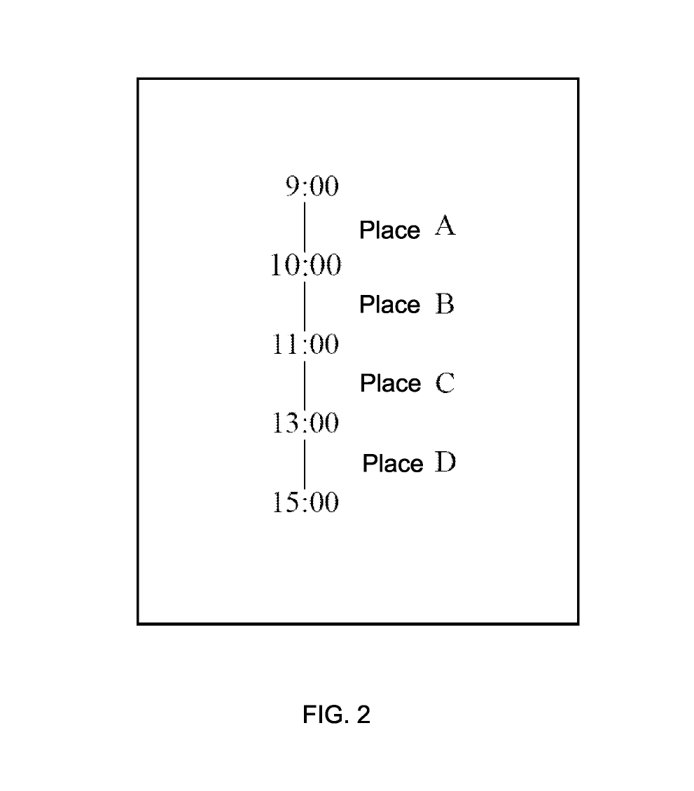

Please refer to FIGS. 1 and 2, FIG. 1 is a flow chart of an automatic tour guiding method according to an embodiment of the disclosure, and FIG. 2 is a schematic diagram of a travel schedule according to an embodiment of the disclosure. An automatic tour guiding method in the disclosure can be performed by a server, an App of a mobile device or a tablet computer, computer software, or any electric device capable of providing a user interface, but the disclosure will not be limited thereto. The following exemplary description related to the automatic tour guiding method is applied to a server.

In step S11, the server produces a time command and a destination command according to a user command. The user command is related to a user's travel requirement. In other words, a user can use a mobile device to upload his or her setting to the server or use other electric devices and a network to upload the setting to the server, but the disclosure will not be limited thereto. For example, after a user links to the server through a mobile device, the server provides the user with a requirement menu such that the user can select one or more requirements or fill in one or more blanks. The requirement menu includes, for example, a time field and a destination field at least. The user can enter departure time, the number of travel days, the end time of travel, or any suitable time data of travel in the one or more time field and enter one or more destinations in the one or more destination field. For example, the destination can be a region, e.g. Taipei City, Taiwan or Manhattan, New York City, or can be a travel attraction, e.g. Taipei 101 or Times Square, New York City. After the user uses the App installed in the mobile device to input some setting in the requirement men, the App will upload the setting in the requirement menu to the server, and then the server produces the above time command according to the content of the time field and produces the above destination command according to the content of the destination field.

In step S13, the server sets a plurality of time indexes according to the time command. For example, if the time field indicates that the departure time is at 9 A.M. on Saturday, the server will make the time command indicate such a departure time, and according to the time command, a time index is set every one hour after 9 A.M. on Saturday. For instance, 10 A.M. on Saturday is set as a time index as 11 A.M. on Saturday is set as another time index, and the rest of time indexes can be deduced by analogy. In other one embodiment, a time index can be set every two hours or every suitable time period. In other one embodiment, a time index can be set according to user's requirements. For example, a time index is set every two hours. For example, a time index is set every one hour/two hours by turns.

In step S15, the server selects place information from a place database according to the destination command. For example, if the destination field indicates a certain region, e.g. New York City, the server transforms the content of the destination field into the above destination command, sends this destination command to the place database, and selects, from the place database, the place information corresponding to the destination command.

In this or some embodiments, the place database includes information about shops or stores, travel attractions, and/or hotels, and such information is referred to as place information. Such information about shops or stores, travel attractions, and/or hotels in the place database can be obtained from cooperative stores, shops, travel attractions, or hotels or from tourists' reports. The disclosure will not be limited by the content and establishment of the place database. In the place database, each piece of place information has a first weight value associated with a distance between the user's departure place and a place of this place information. In this or some embodiments, the departure place can be set by a departure field in the requirement menu or by automatically detecting the user's current location by the Global Positioning System (GPS) executed in a mobile phone, but the disclosure will not be limited thereto.

In this or some embodiments, more travel requirements can be enter into the requirement menu such that the server can produce more requirement commands in response to these travel requirements and select more pieces of place information from the place database according to these requirement commands. For example, the requirement menu further includes a tour type field by which the user can choose a tour theme, such as a culture-and-heritage tour, a culinary tour (referred to as gourmet tour), a natural sight tour, an ecotourism tour, a hot spring tour, a secret place tour, a sport tour, a forest tour or other type tours. The server produces a tourism type command according to the tour type field and sends the tourism type command to the place database in order to select place information from the place database according to the user's desired tour type.

In this or some embodiments, other field in the requirement menu can include a keyword, a distance, a travel theme, the number of tourists, a travel budget, a review score, a travel period, a transportation type, and/or other suitable travel requirements, but the disclosure will not be limited thereto. After one or more travel requirements are inputted, the place information selected from the place database by the server may more match the user's requirement.

In this or some embodiments, a weight value of filtering travel requirements in the place database is preset or manually entered by a user. According to the weight value of filtering travel requirements, the server can check place information piece by piece and select the checked one. For example, if the weight value of review score is predeterminedly higher than that of travel theme, the server will first select the place information with a higher review score in the place database and then select the place information matching the travel theme entered by the user.

In step S17, the server makes each piece of place information correspond to a time index according to the first weight value of the place information to produce a travel schedule. In the case of the first weight value related to a distance between a departure place and a place of one piece of place information, the server sorts the place information obtained in step S15 according to the distance between the departure place and each piece of the place information and makes each piece of the sorted place information correspond to one of the time indexes. For instance, 9:00, 10:00, 12:30, 13:00, and 15:00 are set as time indexes respectively. In this case, the order from the shortest to longest distance between the departure place and a place of the place information is: the place A, B, C, D. The first weight value related to the place A is higher than the first weight value related to the place B as the first weight value related to the place B is higher than the first weight value related to the place C, and the relationship of the first weight values related to the places C and D can be deduced by analogy. According to the first weight values related to the places A, B, C and D, the server allocates the period between the time index of 9:00 and the time index of 10:00 to the place A, allocates the period between the time index of 10:00 and the time index of 12:30 to the place B, allocates the period between the time index of 12:30 and the time index of 13:00 to the place C, and allocates the period between the time index of 13:00 and the time index of 15:00 to the place D, whereby the travel schedule shown in FIG. 2 is produced.

In another embodiment, the place information in the place database is sorted into multiple place categories, e.g. restaurant, travel attraction, hotel, amusement park, or other categories.

In this embodiment, the server further makes each place category correspond to a second weight value. The second weight value is related to the time information corresponding to the place category. For example, a user attempts to go to a restaurant at mealtimes, go to a hotel at night, or go to an amusement park during the business time of the amusement park. Therefore, a second weight value for each piece of place information can be set according to the suitable time to visit a place belonging to the place category related to the place information. For example, the suitable time to visit a restaurant is at mealtimes, e.g. 12:00 A.M. or 6:00 P.M. When the server sets that the place information corresponding to the time index of 12:00 A.M. is a restaurant, the second weight value of the restaurant is higher than that of other place information. For example, since the suitable time to visit a night market E is at night, when the server sets the morning schedule, the second weight value of the night market E in the morning is lower than that at night. Accordingly, in step S17, the server can using the place information and the first and second weight values to produce a travel schedule. In other words, the selection of places to be visited and the order of the places to be visited in the travel schedule can be arranged according to the distance between the departure place and a place of each piece of the place information and the suitable time to visit the place of each piece of the place information.

In an embodiment, the place database further includes multiple tour reports, and each tour report corresponds to at least one piece of place information in the place database. For example, when a user F uploads a tour report H to the server after traveling in a place G, the server defines at least a piece of place information according to the tour report and stores the place information in the place database. For example, the place G includes two travel attractions I and J so that the tour report H corresponds to the place G, the travel attraction I, or the travel attraction J and is stored in the place database. After a user K sets a travel schedule related to the place G, the user K can select the place G. Then, the server produces a selection command according to this selection result, selects a tour report related to the place G in the place database according to the selection command, and provides the user K with the tour report related to the place G.

In each tour report, each piece of place information can have a score. For example, when a tour report H provided by a user F is related to the place G, the travel attraction I, and the travel attraction J, the user F can respectively give the place G, the travel attraction I, and the travel attraction J a score. According to the scores of the place G and the travel attractions I and J, the place information further corresponds to a third weight value. The server further sets a travel schedule according to the first, second and third weight values. In other words, the selection of travel attractions to be visited and the order of travel attractions to be visited in the travel schedule can be set according to the distance between the departure place and the place of each piece of place information, the suitable time to visit the place of each piece of place information, and the score of each piece of place information given by other people.

In an embodiment, the server further provides users with an operation interface according to the place information. The operation interface executes transportation information related to the place information and the time index. For example, after setting the travel schedule, the server can provide a transportation reservation system for the route between the places of any two pieces of place information according to the time indexes of the two pieces of place information in the travel schedule. For example, a user can select a desired departure transportation L in a requirement menu such that the server can provide the user with a reservation system of the transportation L related to the route between a departure place and a destination and a departure time according to the selection of transportation. Then, the user can directly book the transportation L at a certain run of the departure time on the reservation system. In other one embodiment, the operation interface can be a timetable of transportation related to the route from one stop to another.

In another embodiment, the place database further includes event information related to the above place information. For example, the event information can be one or more seasonal festivals, one or more road running activities, one ore more concerts or one ore more art performances related to the place information. When a user selects one piece of place information, the server selects multiple pieces of event information in the place database according to the selected place information to establish an event selection interface and provides the event selection interface for the user to use. In practice, after the server establishes a travel schedule, the user can select one travel attraction M in the travel schedule. Then, the server can select multiple pieces of event information (e.g. the events N, O and P) related to the travel attraction M in the place database and provide them to the user. Therefore, the user can schedule one ore more events to join in the travel attraction M after obtaining the event information related to the travel attraction M.

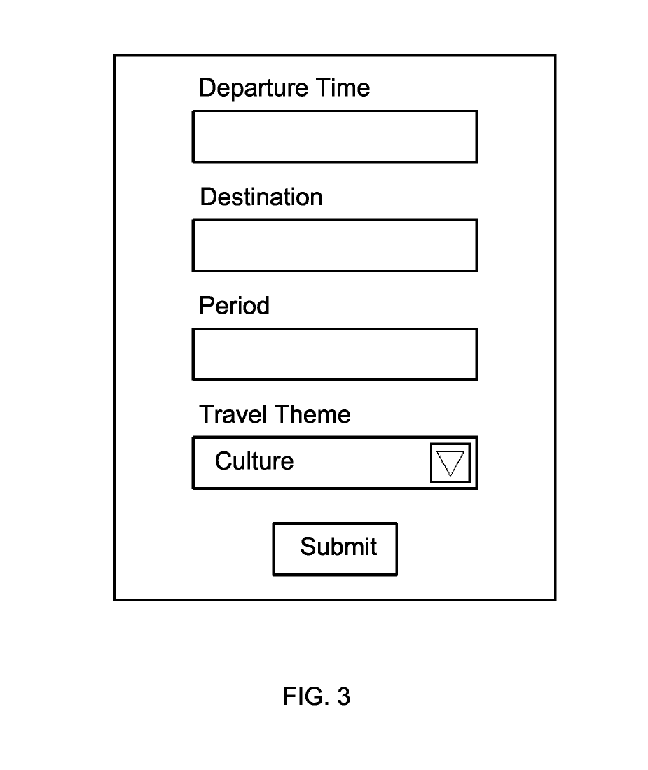

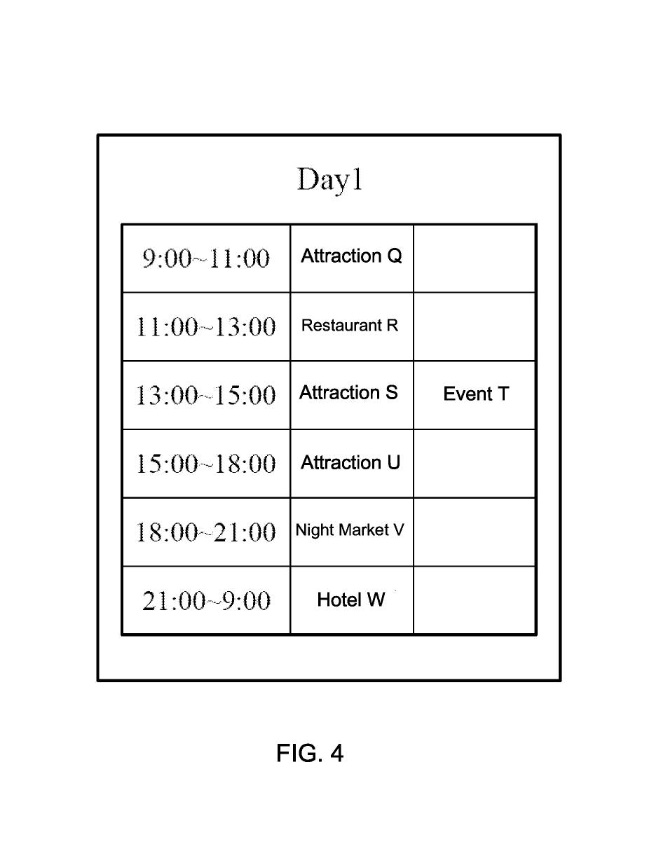

To clearly describe the disclosure, the automatic tour guiding method is carried out by an App installed in a mobile device. Please refer to FIGS. 3 and 4. FIG. 3 is a schematic diagram of a requirement menu according to an embodiment of the disclosure, and FIG. 4 is a schematic diagram of a travel schedule according to an embodiment of the disclosure. As shown in FIG. 3, a requirement menu shown on a screen of the mobile device includes a time field of departure time, a destination field of travel destination, a time field of travel period, and a theme field of travel theme so that a user can enter travel requirements in the requirement menu.

After the user enters travel requirements in the requirement menu, the requirement menu is sent to the server performing the method. The server selects suitable place information in the place database according to the departure time, destination, travel period and tour theme which the user selects, and arranges the order of the selected place information according to the time indexes, the distance between a departure place and the place of the place information, the suitable time to visit the place of the place information, and the tourist's appraisal, so as to produce a travel schedule, as shown in FIG. 4. Then, the travel schedule will be displayed on the screen for the user to read, and/or will be stored.

In an embodiment, the server further produces an itinerary map according to the above travel schedule. The itinerary map corresponds to a geographic map, and the place to stop and the travel track can be marked in the itinerary map according to geographic information in the travel schedule. When the user travels with the automatic tour guiding method, the server further provides a sense message (e.g. the nearby parking information, the local weather, and the number of visitors) related to the place information, but the disclosure will not be limited thereto. For example, when one piece of place information in the travel schedule indicates the National Palace Museum, the server can know the number of visitors in the National Palace Museum according to the information provided by the National Palace Museum. When the number of visitors in the National Palace Museum is too much, the server can select other pieces of place information in the place database in respect of the tourism route and transform the selected place information into a scheme editing interface for the user to select.

What is newly selected in the scheme editing interface forms an editing command. According to the editing command, the server appoints the place of the newly-selected place information to be a new travel place and deletes the place information that the number of visitors is too much. The server further updates the travel schedule according to the first weight value of the newly-selected place information and the first weight value of the rest of place information in the travel schedule. In other words, the server establishes a new travel schedule according to the distance between the user's current location and the place of the newly-selected place information and the distance between the user's current location and the place of the rest of place information in the travel schedule.

In other one embodiment, the server further supports the download of itinerary maps, whereby the user can use the mobile device and the GPS to obtain the travel guidance when traveling according to the downloaded itinerary map.

As set forth above, the automatic tour guiding method can select information about multiple travel attractions in the place database according to the user's travel requirements and can plan a travel schedule according to the weight values related to these travel attractions. Therefore, the disclosure may automatically provide a customization travel schedule without any tour operator and the advance research and planning, thereby reducing the travel cost and increasing the travel efficiency and convenience.

What is claimed is:

1. An automatic tour guiding method applied to a server, the automatic tour guiding method comprising:
producing a time command and a destination command both corresponding to a user command from a user;
setting a plurality of time indexes according to the time command;
selecting a plurality of pieces of place information in a place database of the server according to the destination command, each of the pieces of place information corresponding to one of a plurality of first weight values, each of the plurality of first weight values being related to a distance between a departure place and a place of one of the pieces of place information; and
making the pieces of place information correspond to the plurality of time indexes according to the plurality of first weight values to produce and output a travel schedule.

2. The automatic tour guiding method according to claim 1, further comprising:
producing a tourism type command according to the user command; and
selecting the pieces of place information from the place database according to the destination command and the tourism type command.

3. The automatic tour guiding method according to claim 1, wherein the pieces of place information comprise a plurality of place category.

4. The automatic tour guiding method according to claim 3, wherein each of the pieces of place information corresponds to one of a plurality of second weight values, each of the plurality of second weight values is related to one of a plurality of pieces of time information, the plurality of pieces of time information respectively corresponds to the plurality of place category, and the server makes the pieces of place information correspond to the plurality of time indexes to produce the travel schedule according to the plurality of first weight values and the plurality of second weight values.

5. The automatic tour guiding method according to claim 1, further comprising:
according to the pieces of place information, providing an operation interface for executing transportation information related to at least one of the pieces of place information and at least one of the plurality of time indexes.

6. The automatic tour guiding method according to claim 1, further comprising:
selecting a plurality of pieces of event information corresponding to one of the pieces of place information in the place database according to the pieces of place information; and
providing an event selection interface according to the plurality of pieces of event information.

7. The automatic tour guiding method according to claim 1, further comprising:
producing an itinerary map according to the travel schedule, the itinerary map corresponding to a geographic tourism route.

8. The automatic tour guiding method according to claim 7, further comprising:
selecting the place information related to the itinerary map from the place database according to a sense message of one of the pieces of place information in the travel schedule;
providing a scheme editing interface showing the place information related to the itinerary map;
according to an editing command, selecting one of the pieces of place information shown in the scheme editing interface, and deleting the place information corresponding to the sense message; and
using the rest of the pieces of place information in the travel schedule and the place information indicated by the editing command to updating the travel schedule according to the first weight value of the place information indicated by the editing command and according to the first weight value of the rest of the pieces of place information in the travel schedule.
